(19) United States
(12) Patent Application Publication
(10) Pub. No.: US 2007/0107041 A1
(43) Pub. Date: May 10, 2007

(54) Information processor, method and program for controlling incident response device

(76) Inventors: Makoto Kayashima, Yokohama (JP); Kazushi Nakagawa, Fujisawa (JP); Hiromi Isokawa, Fujisawa (JP); Itsuki Watanabe, Ebina (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/386,787

(22) Filed: Mar. 23, 2006

(30) Foreign Application Priority Data
Nov. 4, 2005 (JP) 2005-320854

(51) Int. Cl. H04L 9/00

(52) U.S. Cl. 726/1

(57) ABSTRACT

An information processor, which controls an incident response device to perform an incident response toward a communication device, realizes the following functions: detecting an incident occurrence in the communication device; storing response information which is information indicative of the incident response that the incident response unit should perform, and target information which is information to identify the communication device, with corresponding policy information regarding a response policy to an incident; outputting a list of the policy information when the incident occurrence is detected; receiving a selection of the policy information; retrieving the response information and the target information corresponding to the selected policy information, from the memory; and sending the incident response unit a command to perform the incident response based on the retrieved response information toward the communication device identified based on the retrieved target information.

### CROSS-REFERENCE TO RELATED APPLICATIONS

This application claims priority based on Japanese patent application No. 2005-320854 filed on Nov. 4, 2004, the entire contents of which are incorporated herein by reference.

### BACKGROUND

The present invention relates to an information processor, a method and program for controlling an incident response device.

In recent years, the importance of a response (hereinafter referred to as “incident response”) to a computer security incident (hereinafter abbreviated to “incident”) in a communication system has been recognized. Japanese Patent Application Laid-open Publication No. 2003-288282 discloses a program for preventing unauthorized accesses via a network.

### SUMMARY OF THE INVENTION

According to the program disclosed in Japanese Patent Application Laid-open Publication No. 2003-288282 or other such conventional techniques, a processing is automatically executed based on a predetermined rule. Therefore, an operator cannot flexibly determine which incident response to be performed, in accordance with a location where an incident has occurred and an importance level of the incident.

The present invention has been contrived in consideration of such circumstances, and it is an object of the invention to provide an information processor capable of providing an operator with a possible incident response, and a method and program for controlling an incident response device.

In order to solve the aforementioned problem, a primary aspect of the present invention is an information processor for controlling an incident response device which performs an incident response toward a communication device, comprising an incident detecting unit for detecting an incident occurrence in the communication device, a response policy storage unit for storing response information which is information indicative of the incident response that the incident response device should perform, and target information which is information to identify the communication device toward which the incident response is to be performed, with corresponding policy information regarding a response policy to an incident, a policy list out put unit for out putting a list of the policy information stored in the response policy storage unit when an incident occurrence is detected, a policy selection unit for receiving a selection of the policy information, a response policy retrieving unit for retrieving the response information and the target information corresponding to the selected policy information, from the response policy storage unit, and a command sending unit for sending the incident response device a command to perform the incident response based on the retrieved response information toward the communication device identified based on the retrieved target information.

According to the present invention, it is possible to provide an operator with a possible incident response.

These and other benefits are described throughout the present specification. A further understanding of the nature and advantages of the invention maybe realized by reference to the remaining portions of the specification and the attached drawings.

### BRIEF DESCRIPTION OF THE DRAWINGS

FIG. 1 exemplifies the overall configuration of an implementation of a communication system according to the present invention;

FIG. 2 exemplifies the hardware configuration of an IDS 20;

FIG. 3 exemplifies the software configuration of the IDS 20;

FIG. 4 exemplifies a configuration example of incident information 61;

FIG. 5 exemplifies the hardware configuration of a router 30;

FIG. 6 exemplifies the software configuration of the router 30;

FIG. 7 exemplifies an example of a configuration file 62;

FIG. 8 exemplifies the hardware configuration of a manager device 40;

FIG. 9 exemplifies the software configuration of the manager device 40;

FIG. 10 exemplifies the configuration of an incident information database 45;

FIG. 11 exemplifies the configuration of a device management database 46;

FIG. 12exemplifies the configuration of template information;

FIG. 13 exemplifies the flow of the process for registering template information;

FIG. 14 exemplifies a setting information registration screen 71;

FIG. 15 exemplifies an incident monitor screen 72;

FIG. 16 exemplifies the flow of the process for controlling the router 30 by the manager device 40;

FIG. 17 exemplifies each of response policy selection screens 73 and 74;

FIG. 18 exemplifies the flow of the process for determining recommendation levels for response policies by a recommendation level determining unit 413;

FIG. 19 exemplifies tables that hold scores used in determining recommendation levels for response policies; and

FIG. 20 exemplifies flows of processes in a communication system configured such that the manager device 40 is used as a server, and a working terminal is used as a client to access the server.

### DETAILED DESCRIPTION OF THE EMBODIMENTS

Overall Configuration

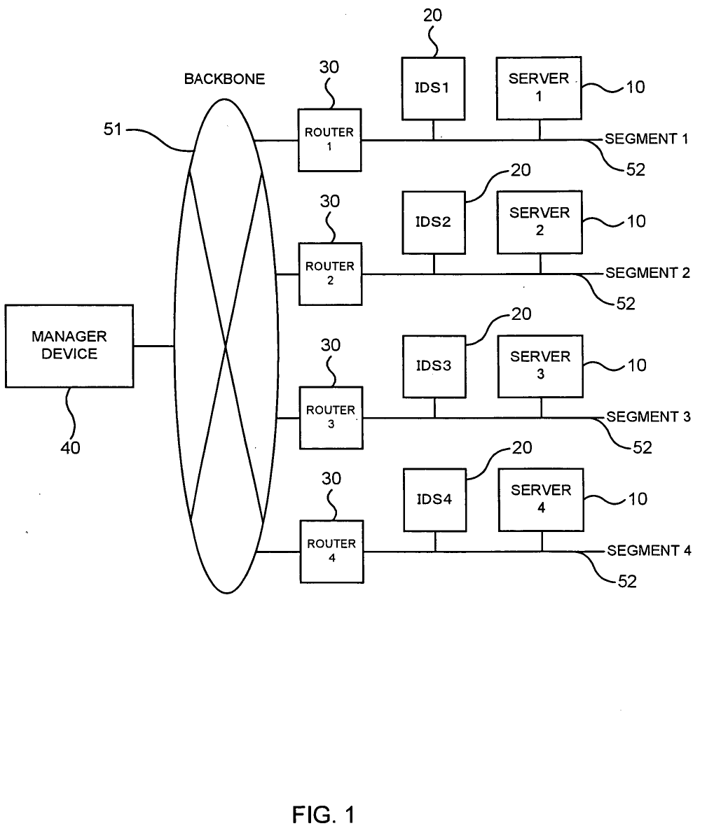

FIG. 1 shows the overall configuration of an implementation of a communication system according to the present invention. As shown in FIG. 1, in the communication system of this implementation, a plurality of network segments 52 (hereinafter abbreviated to “segments 52”) is connected to a backbone network 51 (hereinafter abbreviated to “backbone 51”) laid in an organization through routers 30. In this implementation, the backbone 51 and the segments 52 are configured to form a communication network with the Ethernet (registered trademark), a public telephone line or other means, and it is assumed that communications on this network are executed based on the TCP/IP protocol.

A server 10 which provides information processing services, and an intrusion detection system 20 (hereinafter referred to as “IDS 20”) which detects an incident that has occurred in the server 10 are connected to each segment 52.

The server 10 is a computer for processing information. The incident that has occurred in the server 10 refers to an incident related to computer security, for example, an unauthorized use of resources, interference with services, a destruction of data, an information leakage without consent, and others. Specifically, there are included an unauthorized access such as ICMP attack or SYN-Flood attack, and a potential unauthorized access such as access failure that a user tries and fails to log in a predetermined number or more of times or a port scan.

The IDS 20 inspects packets transmitted on the communication network or receives a communication log from the server 10 to detect an incident occurrence in the server 10. The information about the incident detected by the IDS 20 (hereinafter referred to as “incident information”) is sent to a manager device 40.

The manager device 40 is a computer operated by an operator, and displays the incident information notified from the IDS 20 and changes the setting of the router 30 in accordance with the operator's instruction.

The router 30 is a computer for executing routing control between the backbone 51 and the segment 52, and controls packet transfer. The router 30 has a so-called firewall function and thus can control communications with the server 10. In this implementation, the router 30 functions as an incident response unit that performs incident responses, blocking the communications with the server 10 in which the incident has occurred.

For the sake of the simplification of explanation, in this implementation, an incident response to an incident that has occurred in the server 10 means only a blockage of communications with the server 10. However, an incident response by an incident response unit is not limited to this action. In addition to a blockage of communications with the server 10, incident responses may include the change of a user's password managed by the server 10, the update of an application program run on the server 10, the change of a file permission managed by the server 10, the backup or restore of data managed by the server 10, and a packet transfer to another computer which is set aside as an alternative to the server 10.

IDS 20

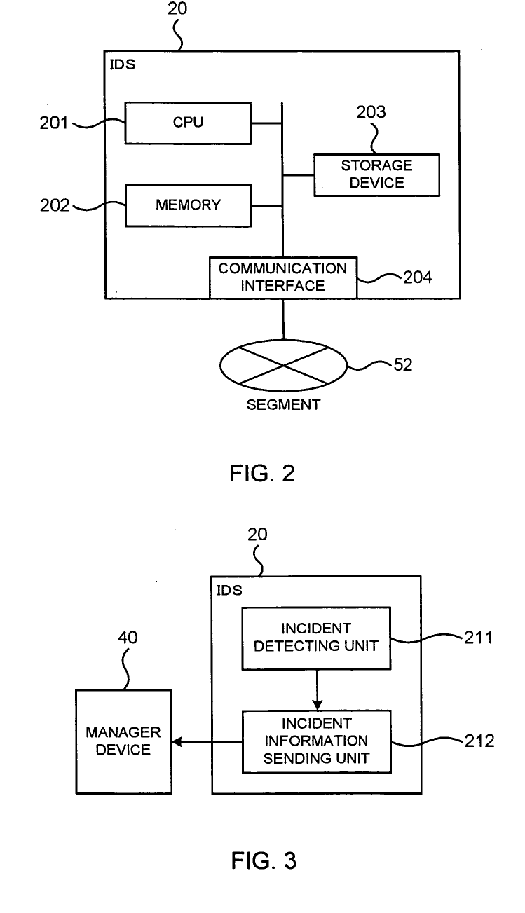

FIG. 2 shows the hardware configuration of the IDS 20. The IDS 20 comprises a CPU 201, a memory 202, a storage device 203, and a communication interface 204. The storage device 203 stores programs and data. As the storage device, for example, a hard disk drive, a CD-ROM drive, or a flash memory is used. The CPU 201 reads out a program stored in the storage device 203 to the memory 202, and executes the program to realize various functions. The communication interface 204 is an interface for connection with the segments 52. The communication interface 204 is, for example, an adaptor connected with the Ethernet (registered trademark) or a modem connected with a public telephone line.

FIG. 3 shows the software configuration of the IDS 20. The IDS 20 comprises an incident detecting unit 211 and an incident information sending unit 212.

The incident detecting unit 211, for example, captures packets transmitted through the segment 52 or receives a communication log from the server 10 to detect whether or not an incident has occurred in the server 10. The incident detecting unit 211 can detect an incident using a method adopted in commonly used intrusion detection devices.

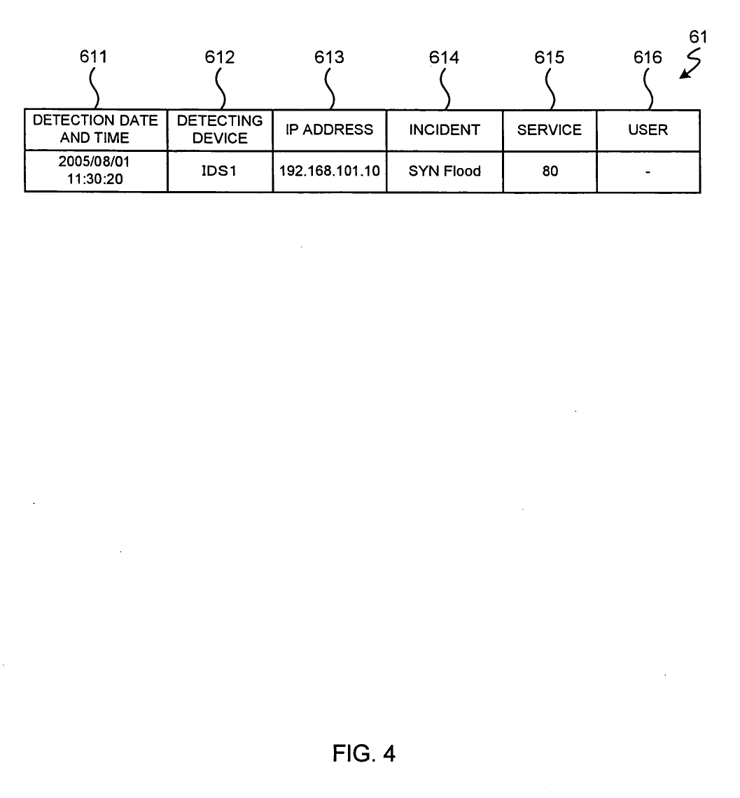

The incident information sending unit 212 sends the manager device 40 incident information 61 about an incident detected by the incident detecting unit 211. FIG. 4 shows a configuration example of the incident information 61 to be sent by the incident information sending unit 212. The incident information 61 comprises a detection date and time 611 that indicates when the incident was detected, a detecting device 612 that indicates the name of the IDS 20, an IP address 613 that indicates the network address of the IDS 20, an incident 614 that indicates the detected incident, a service 615 that indicates the server 10's service related to the incident, and a user 616 that indicates the user related to the incident. Some incidents are not related to the user of the server 10. In such cases, “-” is set in the user 616.

Here, the incident detecting unit 211 and the incident information sending unit 212 are realized by the CPU 201's executing the programs stored in the storage device 203.

Router 30

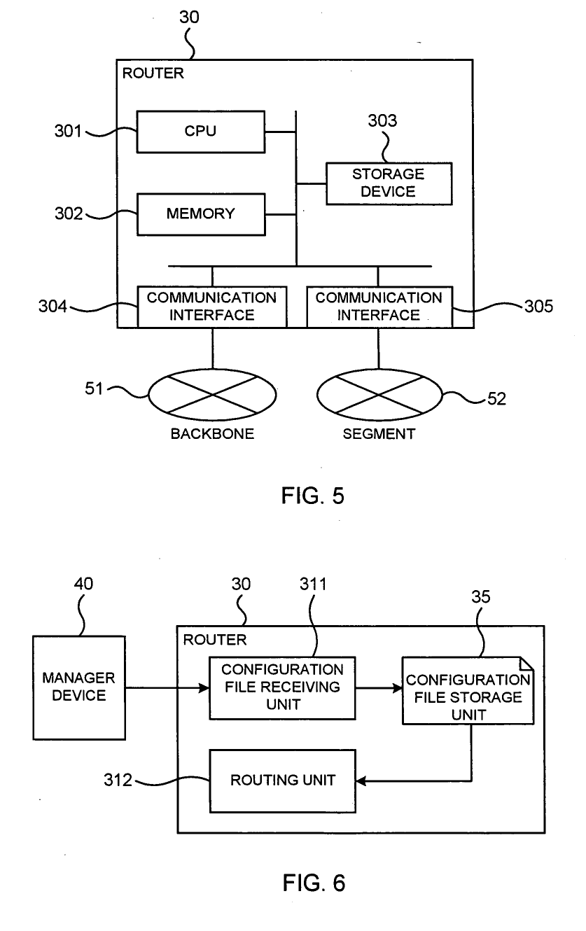

FIG. 5 shows the hardware configuration of the router 30. The router 30 comprises a CPU 301, a memory 302, a storage device 303, and communication interfaces 304 and 305. The storage device 303 stores programs and data. As the storage device, for example, a hard disk drive, a CD-ROM drive or a flash memory is used. The CPU 301 reads out a program stored in the storage device 303 to the memory 302, and executes the program to realize various functions. The communication interface 304 is an interface for connection with the backbone 51. The communication interface 305 is an interface for connection with the segment 52. The communication interface 304 or 305 is, for example, an adaptor connected with the Ethernet (registered trademark) or a modem connected with a public telephone line.

FIG. 6 shows the software configuration of the router 30. The router 30 comprises a configuration file receiving unit 311, a routing unit 312, and a configuration file storage unit 35.

The configuration file receiving unit 311 receives a configuration file 62 which is related to routing and is sent from the manager device 40 described below, and then stores the received file 62 in the configuration file storage unit 35.

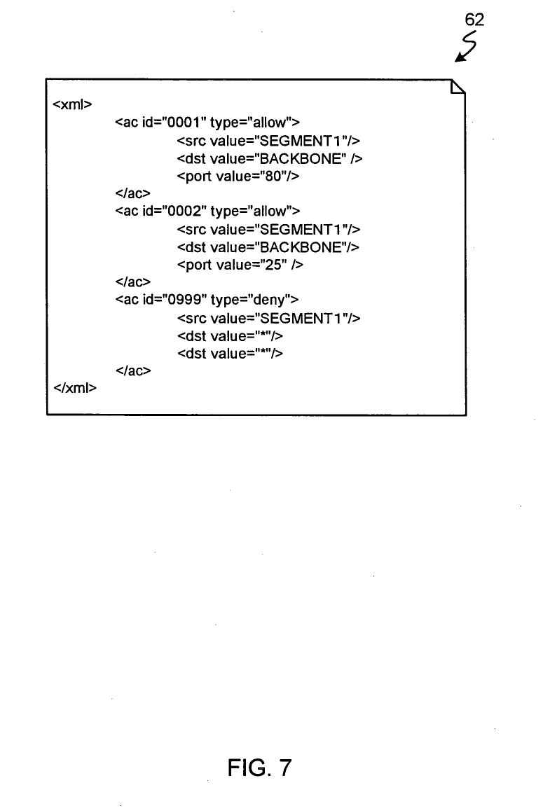

The configuration file 62 includes a rule that defines whether or not to allow packet transfer. FIG. 7 shows an example of the configuration file 62. In the example of FIG. 7, the configuration file 62 is written in the XML format. In this configuration file 62, each rule is set within one <AC> tag. In the <AC> tag, “allow” or “deny” is set as a type attribute. If “allow” is set in the type attribute, the packet transfer is allowed. If “deny” is set in the type attribute, the packet transfer is denied. Also in this configuration file 62, as children of the <AC> tag, a <SRC> tag, a <DST> tag, and a <PORT> tag are provided. As the value attributes in the <SRC> tag and the <DST> tag, the conditions of a packet sender and a packet receiver are specified respectively. Furthermore, in the <PORT> tag, the number of a port to which the server 10 provides a service is specified as the value attribute. A wildcard (“*”) can be set as the value attributes of the respective tags. The example of FIG. 7 shows the <AC> tag having an id attribute of “0001” in which packets are “allowed” to be transferred from “segment 1” to “backbone” through the port of number “80”.

The routing unit 312 handles packet routing between the backbone 51 and the segment 52. The routing processing by the routing unit 312 is the same as one by a general router. The router 30 references the configuration file 62 stored in the configuration file storage unit 35 and applies the rules from the top in the file to the packet to be transferring, and then determines whether or not the packet can be transferred. The example of FIG. 7 shows that, with the <AC> tag having the id attribute “0999”, all packets other than packets addressed to the port of number “80” or “25” should be denied to be transferred. Hence, when the router 30 follows the configuration file 62 of FIG. 7, only the packets addressed to the port of number “80” or “25” can be transferred.

Meanwhile, the configuration file receiving unit 311 and the routing unit 312 are realized by that the CPU 301 included in the router 30 reads out the program stored in the storage device 303 to the memory 302, and executes the program. Furthermore, the configuration file storage unit 35 is provided as a storage area in the memory 302 or the storage device 303 of the router 30.

Manager Device 40

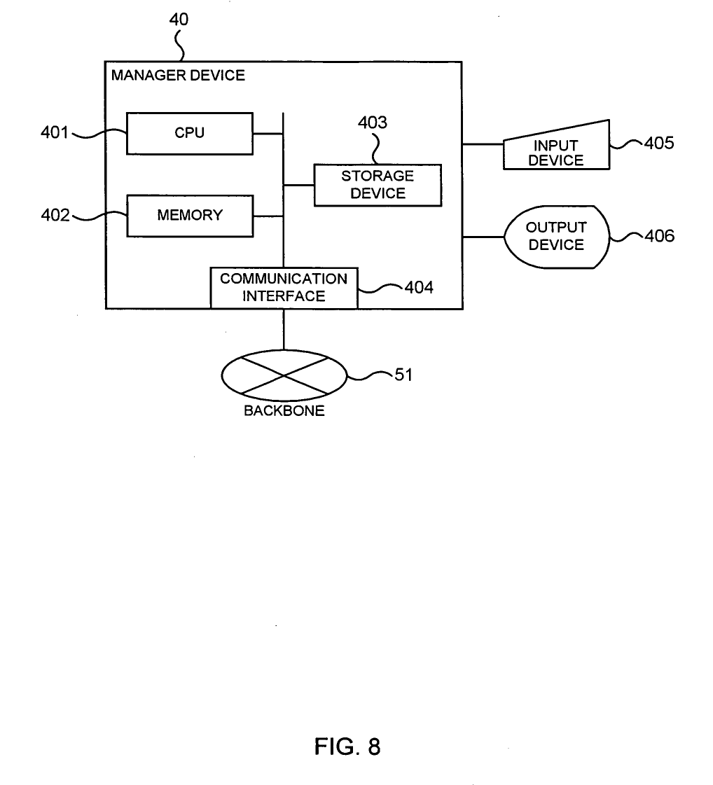

FIG. 8 shows the hardware configuration of the manager device 40. The manager device 40 comprises a CPU 401, a memory 402, a storage device 403, a communication interface 404, an input device 405, and an output device 406. The storage device 403 stores programs and data. As the storage device, for example, a hard disk drive or a CD-ROM drive is used. The CPU 401 reads out a program stored in the storage device 403 to the memory 402, and executes the program to realize various functions. The communication interface 404 is an interface for connection with the backbone 51. For example, the communication interface is an adaptor connected with the Ethernet (registered trademark) or a modem connected with a public telephone line.

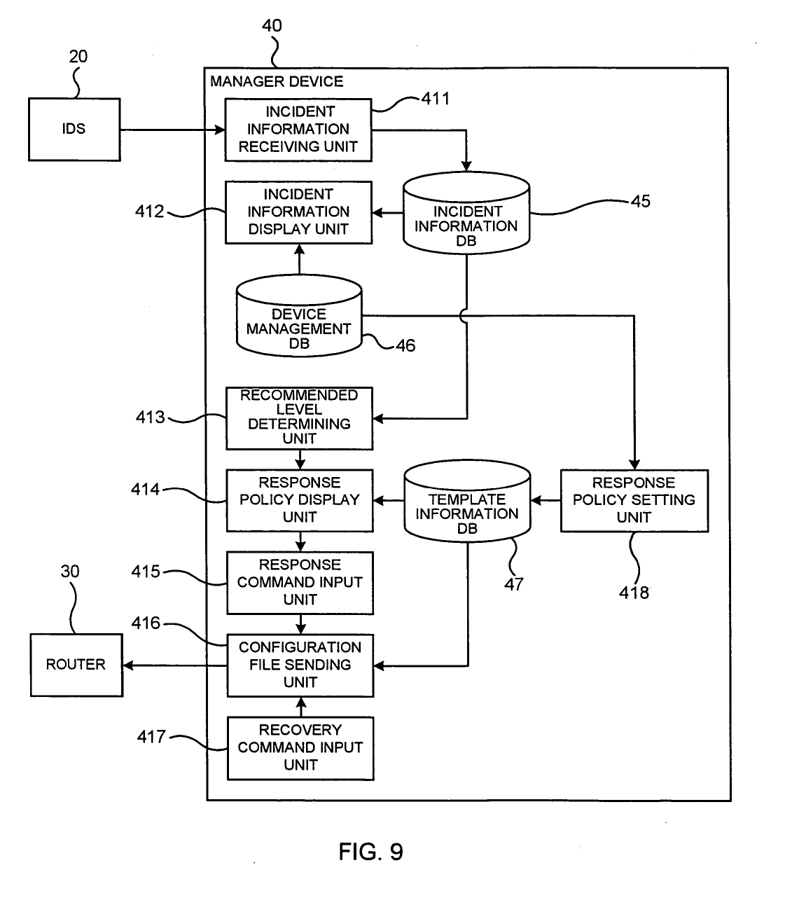

FIG. 9 shows the software configuration of the manager device 40. The manager device 40 comprises function parts such as an incident information receiving unit 411, an incident information display unit 412, a recommendation level determining unit 413, a response policy display unit 414, a response command input unit 415, a configuration file sending unit 416, a recovery command input unit 417, and a response policy setting unit 418, and databases such as an incident information database 45, a device management database 46, and a template information database 47.

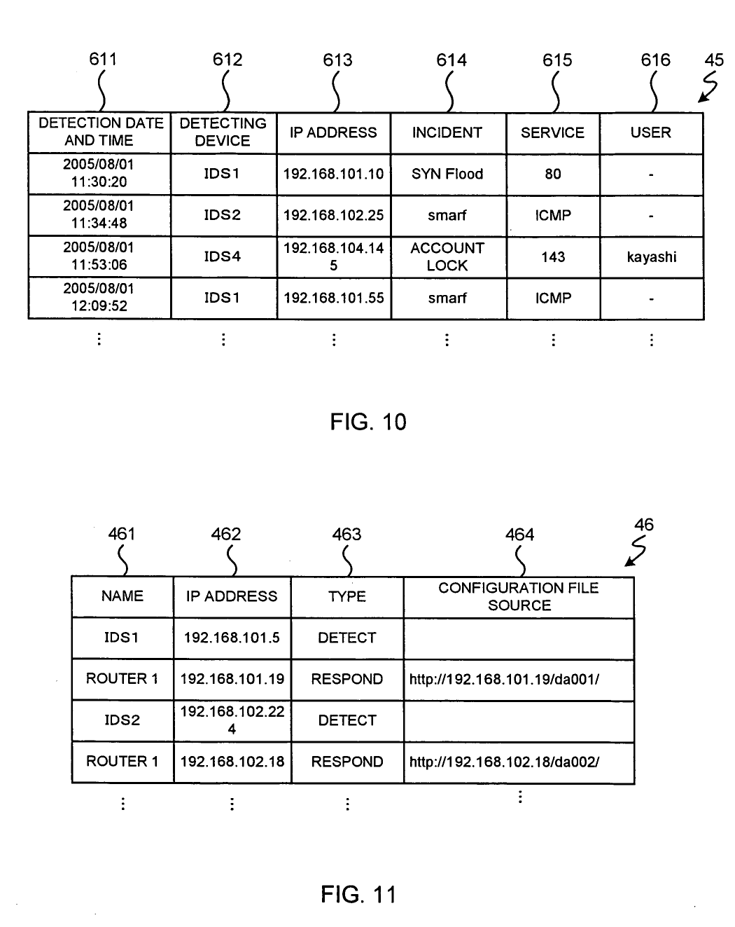

The incident information database 45 stores the incident information 61 sent from the IDS 20. FIG. 10 shows the configuration of the incident information database 45. As shown in FIG. 10, the incident information database 45 records the history of the aforementioned incident information 61 of FIG. 4.

The device management database 46 stores information about the IDS 20 and the router 30 (hereinafter collectively referred to as “agent”) managed by an operator at the manager device 40. FIG. 11 shows the configuration of the device management database 46. As shown in FIG. 11, the device management database 46 stores an agent name 461, an agent IP address 462, an agent type 463, and a configuration file source 464, coordinating each item. In the type 463, “detect” or “respond” is set. If the “detect” is set in the type 463, the agent is the IDS 20 for detecting an incident. If the “respond” is set in the type 463, the agent is the router 30 for making an incident response. If the agent is the router 30, the configuration file source 464 is URL (Uniform Resource Locator) for an access to the configuration file 62 managed by the router 30. The configuration file source 464 is not limited to URL as long as it indicates where the configuration file 62 is stored.

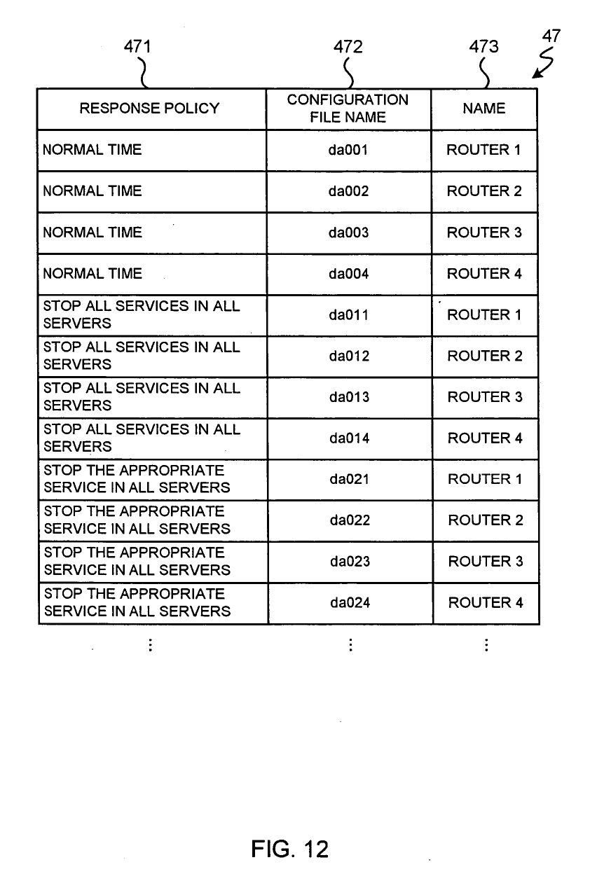

The template information database 47 stores information including a response policy applied when an incident has occurred in the server 10, and a configuration file 62 to be sent to the router 30 (hereinafter referred to as “template information”). FIG. 12 shows the configuration of the template information. As shown in FIG. 12, the template information stores a configuration file name 472, and a name 473 of a router as destination of the configuration file 62, coordinating with a response policy 471 that indicates a policy in an incident occurrence. The configuration file name 472 indicates the name of the configuration file 62 managed by the manager device 40. In this implementation, the response policy 471 has one of five kinds of policies “normal time”, “stop all services in all servers”, “stop only the appropriate service in all servers”, “stop all services in the appropriate server”, and “stop only the appropriate service in the appropriate server”.

The incident information receiving unit 411 receives the incident information 61 sent from the IDS 20 and registers the received incident information 61 in the incident information database 45. The incident information display unit 412 displays the incident information 61 registered in the incident information database 45. A screen example of the incident information display unit 412 displaying the incident information 61 is shown later.

The recommendation level determining unit 413 determines recommendation levels of response policies to an incident (sequence of response policies). The process for determining recommendation levels of the response policies is described in detail later. The response policy display unit 414 displays the response policies in the descending order of their recommendation levels. An example of a screen displaying the response policies is shown later.

The response command input unit 415 receives an entry of a command to perform an incident response (hereinafter referred to as “response command”). In this implementation, the response command input unit 415 receives a selection of a response policy on the response policy display screen as entry of a response command.

The recovery command input unit 417 receives an entry of a command to reset the setting of the router 30 to the previous one which has been changed in accordance with the incident response (hereinafter, referred to as “recovery command”). The recovery command may be entered using a keyboard or the like, or entered by clicking a button displayed on the screen with a mouse.

The configuration file sending unit 416 sends the router 30 the configuration file 62 corresponding to the response policy selected by an operator. In this implementation, the configuration file sending unit 416 reads out the template information from the template information database 47, and sends the configuration file 62 specified in the configuration file name 472 to the router 30 in the name 473.

The response policy setting unit 418 creates template information and registers it in the template information database 47.

Template Information Registration

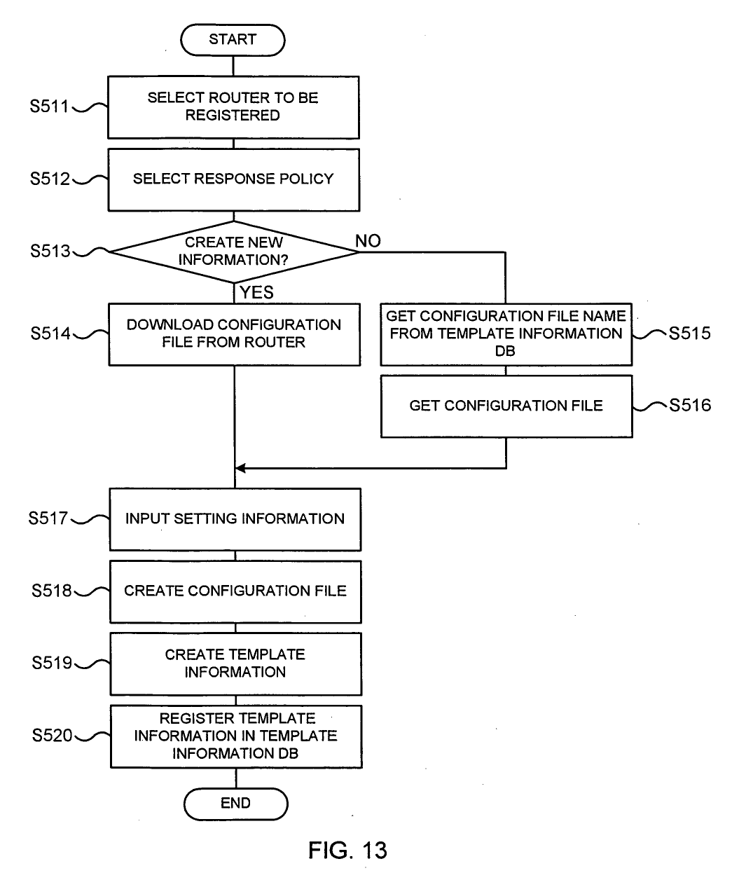

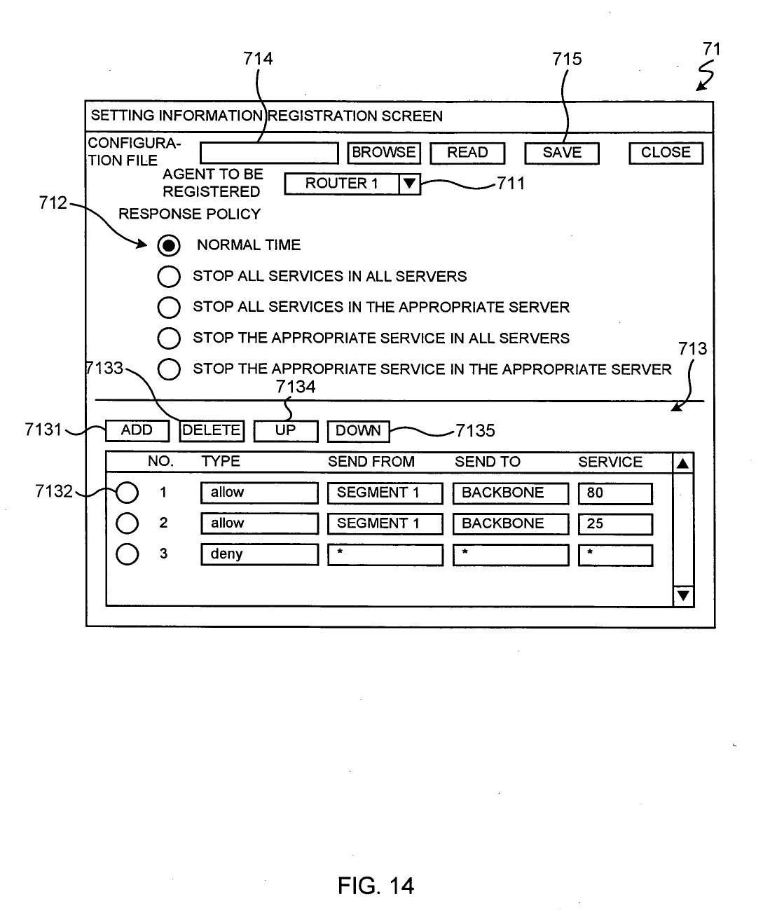

FIG. 13 shows the flow of the process for registering template information. FIG. 14 shows an example of a setting information registration screen 71 used for registering template information.

The setting information registration screen 71 includes a pull-down list 711 for selecting a router 30 to be registered, and option buttons 712 for selecting a response policy. The response policy setting unit 418 reads out the name(s) in 461 with “respond” set in the type 463 from the device management database 46, and sets the list of the read name(s) 461 in the pull-down list 711.

The setting information registration screen 71 includes an edit box 713 showing the setting information written in each <AC> tag(s) of the configuration file 62. Each line of the edit box 713 corresponds to one <AC> tag. The number of the <AC> tags can be increased by an operator's clicking an “add” button 7131 in the upper portion. Moreover, when a “delete” button 7133, an “up” button 7134, or a “down” button 7135 is clicked after a radio button 7132 provided at the head of each setting information line is selected, the selected setting information can be deleted or the order of the setting information can be rearranged accordingly.

Furthermore, the setting information registration screen 71 includes an entry field 714 for specifying a configuration file 62. An operator can specify a created configuration file 62 without using the edit box 713.

Once receiving selections of the router 30 to be registered from the pull-down list 711 (S511) and the response policy by a click on the option button 712 (S512), the response policy setting unit 418 starts to search the template information database 47 for the template information corresponding to the selected router 30 and response policy. If the corresponding template information cannot be found (S513: YES), the configuration file source 464 corresponding to the selected router 30 is retrieved from the device management database 46, and the configuration file 62 specified in the retrieved configuration file source 464 is obtained (S514). On the other hand, if the corresponding template information is found (S513: NO), the configuration file name 472 is retrieved from the template information database 47 (S515), and the configuration file 62 specified in the configuration file name 472 is obtained (S516).

The response policy setting unit 418 lists the setting information in the edit box 713 based on the thus-acquired configuration file 62, and receives an entry about setting information from an operator (S517). The response policy setting unit 418 creates a configuration file 62 based on the entered setting information (S518), creates a template information in which the selected response policy, the selected router 30, and the name of the created configuration file 62 are set (S519), and then registers the created template information in the template information database 47 (S520).

It should be noted that at the time of creating setting information, the information should be created to cover all possible combinations of senders, receivers, and services. Also in the example of FIG. 14, wildcards are used in the third setting information so that the packets not matching with conditions set in the first and second information are denied to be transferred with respect to all senders, receivers, and services.

Furthermore, in this registration, all possible combinations of the routers 30 and the response policies should be covered.

In this way, the template information database 47 stores and manages the configuration file 62 which is used for controlling the incident response performed by the router 30 (in this implementation, a blockage of communications with the server 10) in accordance with one of the above four response policies when an incident has occurred in the server 10.

Incident Monitor Screen

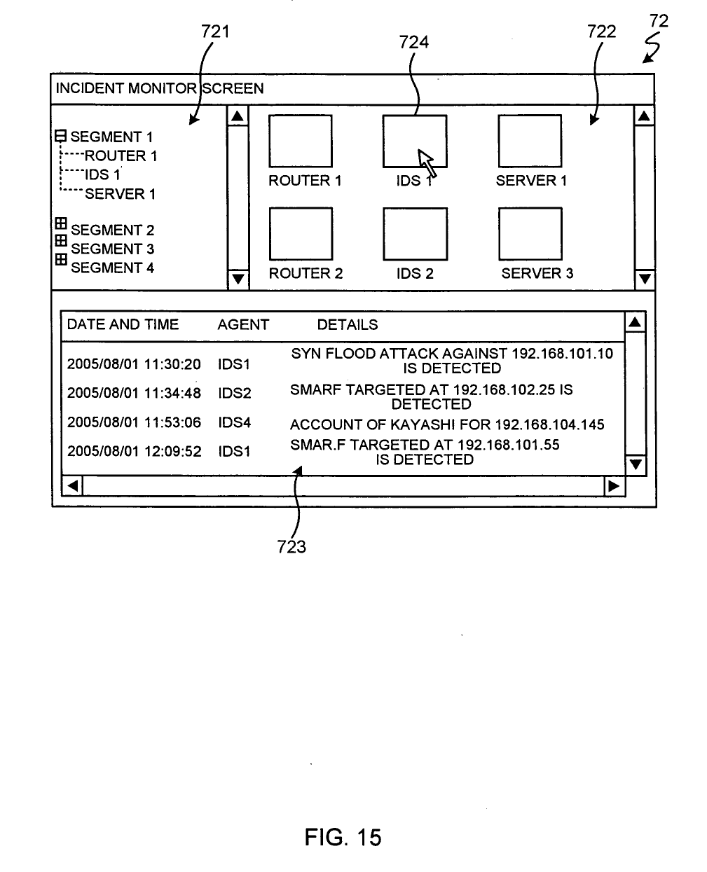

The manager device 40 of this implementation displays the incident information 61 reported by the IDS 20 to allow an operator to monitor the occurrence of an incident. FIG. 15 shows an example of a screen 72 displaying the incident information 61 (hereinafter, referred to as “incident monitor screen 72”). As shown in FIG. 15, the incident monitor screen 72 includes a directory pane 721 that shows the network configuration of the communication system in tree structure, a device pane 722 in which communication devices are lined up, and a list box 723 in which the incident information 61 are listed.

In the directory pane 721 are displayed the server 10, the IDS 20 and the router 30 which are connected with each of the segments 52 from “segment 1” to “segment 4”.

In the device pane 722, the communication devices connected with the backbone 51 and the segments 52 are lined up in the form of icon. The displayed icons may be changed depending on the type of a communication device. Also, it is possible to set like when a segment 52 is selected in the directory pane 721, the communication devices displayed in the device pane 722 are changed accordingly. In this case, when “segment 1” is selected in the directory pane 721, only the communication devices connected with “segment 1”, that is, “server 1, “IDS 1”, and “router 1” are listed in the device pane 722.

The list box 723 shows a history of the incident information 61 registered in the incident information database 45. The incident information display unit 412, for example, reads out the incident information 61 detected from the current time to a predetermined time ago, from the incident information database 45 and lists the information in the list box 723 in the order of the detection date and time 611.

Meanwhile, in the device pane 722, the IDS 20 specified in the detecting device 612 of the incident information 61 and the server 10 corresponding to the IP address in 613 may be highlighted.

Controlling Router 30

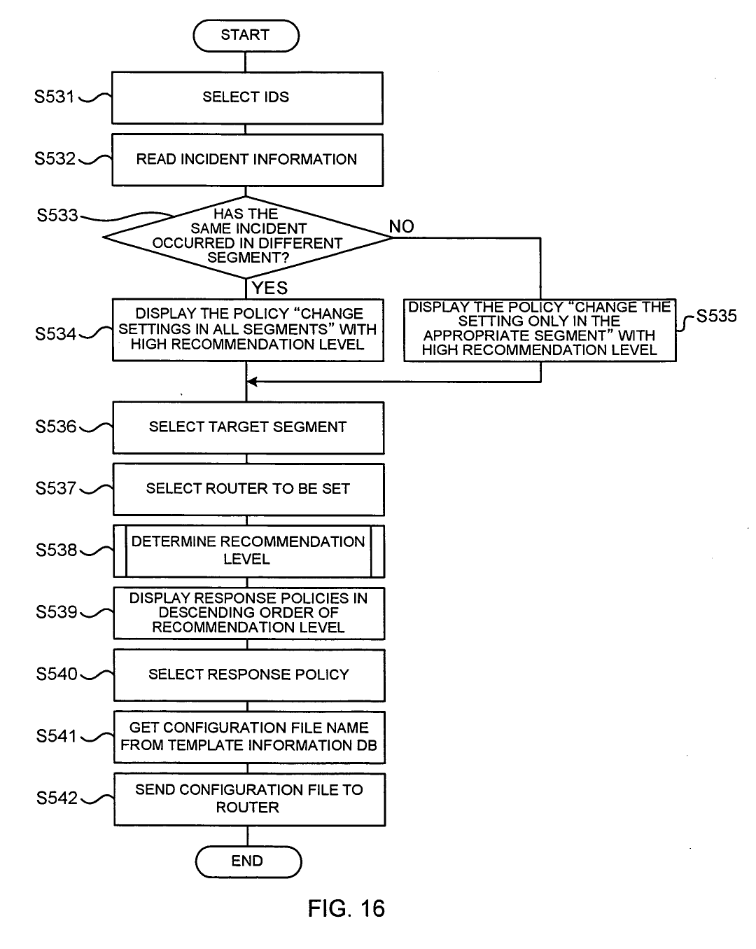

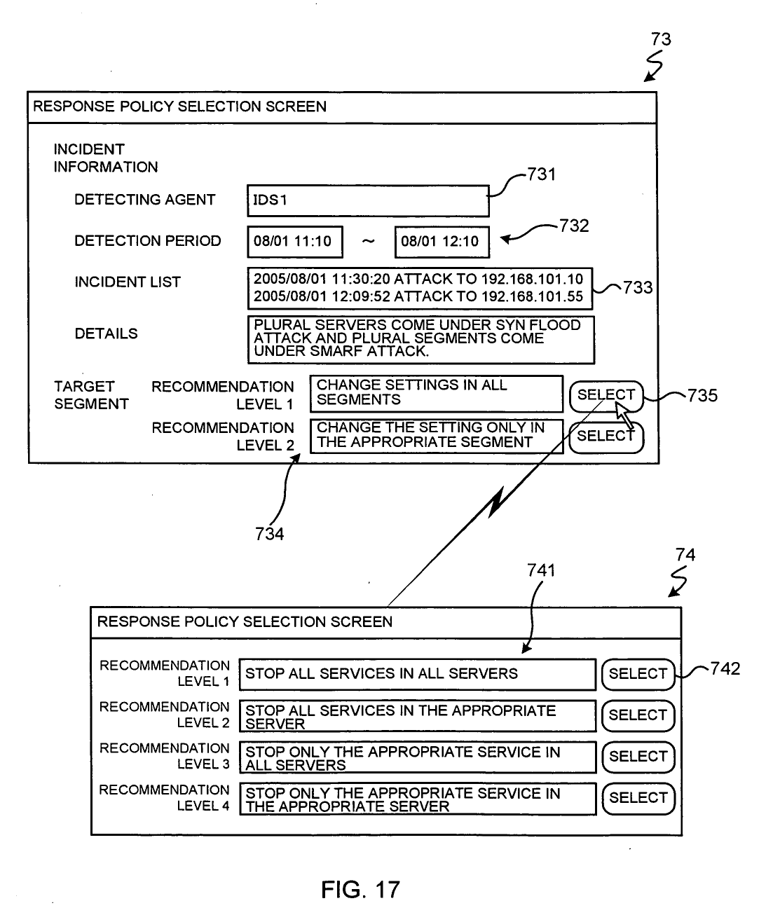

When the IDS 20 is selected in the device pane 722 on the incident monitor screen 72, the manager device 40 displays a list of response policies to the incident detected by the selected IDS 20, and controls the router 30 to perform an incident response corresponding to the response policy selected by an operator. FIG. 16 shows the flow of the process for controlling the router 30 by the manager device 40. FIG. 17 shows an example of each of response policy selection screens 73 and 74 used in this process.

When the IDS 20 is selected in the incident monitor screen 72 (S531), the manager device 40 reads out from the incident information database 45 the incident information 61 where the selected IDS 20 (hereinafter referred to as “selected IDS”) is set in the detecting device 612, and the detection date and time 611 falls from the current time to a predetermined time ago (S532). Then, the manager device 40 displays a response policy selection screen 73 of FIG. 17. The response policy selection screen 73 includes a field 731 where the selected IDS is displayed, a field 732 where the above-mentioned period is displayed, and a list box 733 where the read incident information 61 are listed.

The manager device 40 determines whether or not the same incident has occurred in the segment 52 different from the segment 52 connected with the selected IDS for each of the read incident information 61, by finding whether or not the incident information database 45 has the incident information 61 in which the IDS 20 different from the selected IDS is set in the detecting device 612, using the incident 614 as a key (S533). The response policy selection screen 73 includes a field 734 for selecting the segment 52 to which an incident response will be performed. If the same incident has occurred in the different segment 52 (S533: YES), the manager device 40 increases the recommendation level for a segment policy saying “Change settings in all segment” and put it above another policy saying “Change the setting only in the appropriate segment” on the response policy selection screen 73 (S534).

Conversely, if the same incident has not occurred in the different segment 52 (S533: NO), the manager device 40 increases the recommendation level for a segment policy saying “Change the setting only in the appropriate segment” and put it above another policy saying “Change settings in all segments” on the response policy selection screen (S535).

When an operator clicks a select button 735 corresponding to any one of the segment policies which define the extent of target and are displayed on the response policy selection screen 73 (S536), the manager device 40 determines the segment(s) 52 to which the incident response will be performed in accordance with the selected policy, and then determines the router(s) 30 which are in the determined segment(s) 52 and are connected with the backbone 51 as the router(s) 30 to be set (hereinafter referred to as “setting-target router”) (S537). If the segment policy saying “Change settings in all segments” is selected, the manager device 40 determines all the routers 30 registered in the device management database 46 as the setting-target router. Meanwhile, if the segment policy saying “Change the setting only in the appropriate segment” is selected, the manager device 40 identifies the segment 52 from the IP address 613 in each of the incident information 61 retrieved in the above-mentioned step (S532), and identifies the router 30 corresponding to the identified segment 52 from the device management database 46.

The recommendation level determining unit 413 of the manager device 40 determines the recommendation levels for the four response policies which are “Stop all services in all servers”, “Stop only the appropriate service in all servers”, “Stop all services in the appropriate server”, and “Stop only the appropriate service in the appropriate server” (S538), and then the response policy display unit 414 lists the four response policies in order of the determined recommendation level on the response policy selection screen 74 of FIG. 17 (S539). The process for determining the recommendation levels of the response policies is described in detail later.

The response command input unit 415 of the manager device 40 receives a click (response command) on a select button 742 corresponding to any one of the response policies displayed on the response policy selection screen 74 (S540). The configuration file sending unit 416 reads out the template information corresponding to the selected response policy and the selected IDS described above from the template information database 47 (S541), and sends the configuration file 62 specified in the configuration file name 472 to the router 30 in the name 473 (S542).

In this way, the manager device 40 changes the setting of the router 30 in response to an operator's instruction.

Determining Recommendation Level

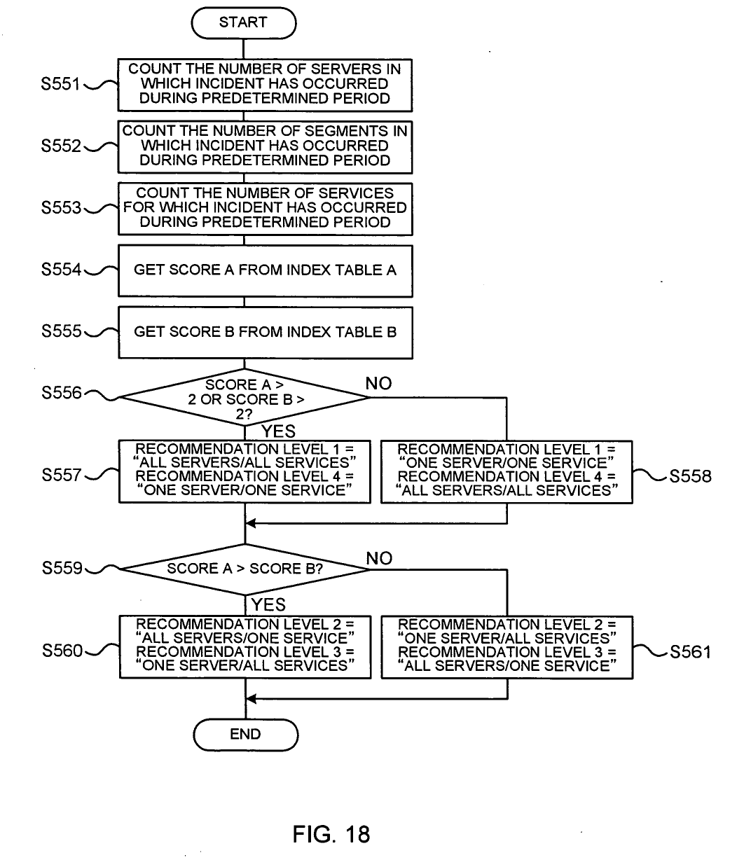

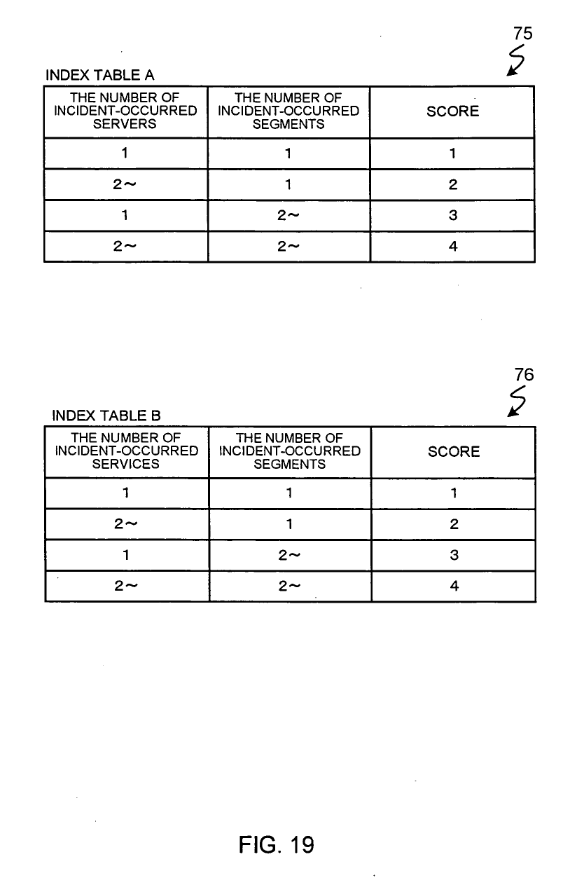

FIG. 18 shows the flow of the process for determining the recommendation levels of response policies by the recommendation level determining unit 413. FIG. 19 shows tables holding scores used in this process. In FIG. 19 are index tables A 75 and B 76. These tables are stored in the storage device 403 or the memory 402 of the manager device 40. The index table A 75 manages scores in association with the number of servers 10 where an incident has occurred (hereinafter, referred to as “the number of incident-occurred servers”) and the number of segments connected with the incident-occurred server 10 out of the segments 1 to 4 (52) (hereinafter, referred to as “the number of incident-occurred segments). The index table B 76 manages scores in association with the number of services related to an incident (hereinafter, referred to as “incident-occurred services”) and the number of incident-occurred segments.

The recommendation level determining unit 413 of the manager device 40 reads out from the incident information database 45 the incident information 61 whose detection date and time 611 falls from the current time to the predetermined time ago (hereinafter referred to as “predetermined period”). Then, the unit extracts IP addresses 613 without duplication from the read incident information 61, and counts the number of extracted IP addresses as the number of incident-occurred servers (S511). In addition, the recommendation level determining unit 413 identifies the segment 52 to which the IP address 613 belongs, for each of the read incident information 61, and extracts the identified segments 52 without duplication, and then count the number of extracted segments as the number of incident-occurred segments (S552). Furthermore, the recommendation level determining unit 413 extracts the services 615 from the read incident information 61 without duplication, and counts the number of extracted services 615 as the number of incident-occurred services (S553).

The recommendation level determining unit 413 references the index table A 75 to obtain the score corresponding to the numbers of incident-occurred servers and incident-occurred segments (hereinafter referred to as “score A”), and references the index table B 76 to obtain the score corresponding to the numbers of incident-occurred services and incident-occurred segments (hereinafter referred to as “score B”) (S555).

If the score A is more than 2, or the score B is more than 2 (S556: YES), the recommendation level determining unit 413 gives the recommendation level of 1 to the response policy saying “Stop all services in all servers” (hereinafter abbreviated to “all servers/all services”), and gives the recommendation level of 4 to the policy saying “Stop only the appropriate service in the appropriate server” (hereinafter abbreviated to “one server/one service”) (S557). That is, the more the numbers of the incident-occurred segments and the incident-occurred servers are, the higher the recommendation level of the response policy therefor is.

On the other hand, if the score A is 2 or less, and the score B is 2 or less (S556: NO), the recommendation level for “one server/one service” is set to 1, while the recommendation level for “all servers/all services” is set to 4 (S558). That is, the more the numbers of the incident-occurred segments and the incident-occurred services are, the higher the recommendation level of the response policy therefor is.

If the score A is larger than the score B (S559: YES), the recommendation level determining unit 413 gives the recommendation level of 2 to the policy saying “Stop only the appropriate service in all servers” (hereinafter abbreviated to “all servers/one service), and gives the recommendation level of 3 to the policy that “Stop all services in the appropriate server” (hereinafter abbreviated to “one server/all services”) (S560). On the other hand, if the score B is larger than the score A (S559: NO), the recommendation level determining unit 413 gives the recommendation level of 2 to the policy “one server/all services,” and gives the recommendation level of 3 to the policy “all servers/one service” (S561).

In this way, the recommendation level determining unit 413 can determine the recommendation levels for the response policies in accordance with the numbers of incident-occurred servers, incident-occurred services and incident-occurred segments.

Thus, if there are a plurality of segments 52 to which the servers 10 that have incurred an incident are connected, the manager device 40 of this implementation can provide an operator with the suitable response policy by recommending him/her to stop communications with enough number of segments 52 using routers 30. On the other hand, if there are a smaller number of segments 52 to which the servers 10 that have incurred an incident are connected, the manager device 40 can provide the suitable response policy with an operator by recommending him/her to stop communications only with the segments 52 that are involved in the incident and continue communications with the remaining segments 52.

Furthermore, if an incident has occurred in plural services, the manager device 40 can provide an operator with the suitable response policy by recommending him/her to stop communications for enough number of services. On the other hand, if an incident has occurred in a smaller number of services, the device 40 can provide the suitable response policy by recommending him/her to stop communications only for the services that are involved in the incident and continue communications for the remaining services.

In this way, the manager device 40 of this implementation can determine the recommendation levels in such a manner that an appropriate and effective incident response can be performed, preventing a further incident and at the same time avoiding unnecessary blockages of communications. Then, the device can provide an operator with the response policies in the descending order of the determined recommendation level. As a result, the operator can select an appropriate and effective incident response based on the output from the manager device 40. Meanwhile, the operator can also flexibly select a response policy for the other incident response in consideration of various conditions as well as the above-mentioned state of the incident occurrence. Briefly stated, the operator can perform an incident response more flexibly.

In this implementation, an incident response is performed by the router 30, but the response may be performed by the server 10. Assuming that a failure of user's login is detected as an incident, for example, it is possible to set that the server 10 reject the access from that user account or the group to which that user belongs from that time onward. In this case, the manager device 40 issues a command to perform the aforementioned incident response, to the server 10. Furthermore, the server 10 can be commanded to perform such an incident response as to update an operating system or application program run by the server 10. In this case, a patch management server to manage patch data for updating the program should be added to the communication system, so that the server 10 can get the patch data from the patch management server and apply it to the operating system or application program.

Besides the router 30 and the server 10, a special incident response unit that performs an incident response maybe additionally provided.

Using Working Terminal

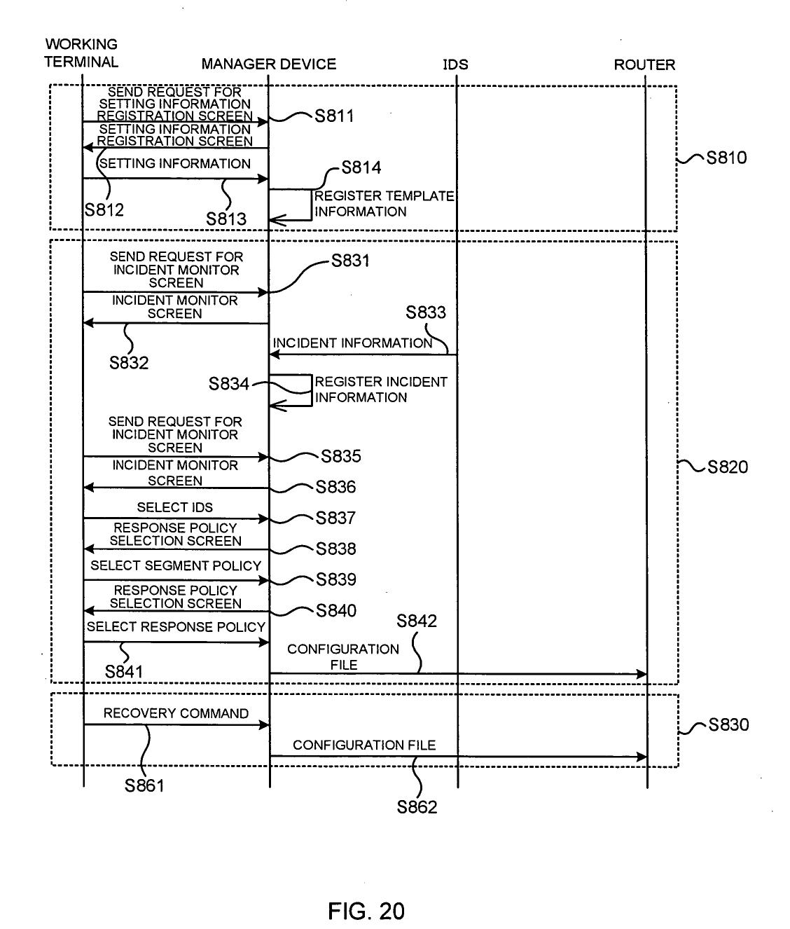

In this implementation, an operator browses the incident information or selects a response policy by operating the manager device 40 itself. However, it is possible to configure the manager device 40 as web server, and a working terminal as client operated by an operator. In this case, each unit of the manager device 40 is realized as CGI program, for example. Then, the operator can access the manager device 40 through a Web browser on the working terminal. FIG. 20 shows flows of processes over the entire communication system in this case. FIG. 20 shows the flows of the process for registering the template information with the above described response policy setting unit 418 (S810), the process for displaying the incident information on the incident monitor screen 72 (S820), and the process for setting the router 30 through an entry of a recovery command (S830).

In registering the template information, an operator operates the working terminal to access the manager device 40, and makes a request to send (send request) the setting information registration screen (S811). The manager device 40 sends screen data for displaying the setting information registration screen 71 to the working terminal in response to the send request (S812). When the operator enters the setting information on the setting information registration screen 71, the setting information is sent from the working terminal to the manager device 40 (S813) and the manager device 40 registers the template information including the received setting information in the template information database 47 in the same way as the above described process of FIG. 12 (S814).

In displaying the incident information, an operator operates the working terminal to access the manager device 40 and makes a request to send the incident monitor screen 72 (S831). The manager device 40 sends screen data for displaying the incident monitor screen 72 to the working terminal in response to the above send request (S832). Meanwhile, the incident information is sent from the IDS 20 to the manager device 40 (S833), and the manager device 40 registers the received incident information in the incident information database 45 (S834). The working terminal regularly makes a request to send the incident monitor screen 72 to the manager device 40 (S835), and the manager device 40 sends the screen data for the incident monitor screen to the working terminal for each send request (S836).

When a list of incident information is displayed in the list box 723 of the incident monitor screen 72, an operator selects the IDS 20 and sends that information to the manager device (S837). In turn, the manager device 40 sends the working terminal the screen data for displaying the response policy selection screen 73 where the segment policies are listed in the descending order of the recommendation level (S838) The operator selects a segment policy this time, and the working terminal sends that information to the manager device 40 (S839). The manager device 40 determines the recommendation level for each response policy, and sends the working terminal the screen data for displaying the response policy selection screen 74 that lists the response policies in the descending order of recommendation level (S840). Then, the operator selects a response policy, and the working terminal sends that information to the manager device 40 (S841). Finally, the manager device 40 sends the router 30 the configuration file 62 corresponding to the selected response policy (S842) to change setting of the router 30.

In resetting the router 30 through the input of a recovery command, the working terminal sends a recovery command to the manager device 40 in accordance with the operator's operation (S861), and then the manager device 40 reads out from the template information database 47 the template information where “normal time” is set in the response policy 471, and sends the configuration file 62 specified in the configuration file name 472 to the router 30 in the name 473 (S862)

In this way, the operator can access the manager device 40 and control the router 30 to perform an incident response by operating the working terminal.

Having described the implementation of the present invention, our aim is to facilitate the understanding of the present invention, and the invention should not be construed limited by any of the details of this description. The present invention can be changed and modified without departing from the scope of the claims, and includes equivalents thereof.

We claim:

1. An information processor for controlling an incident response device which performs an incident response toward a communication device, comprising:
an incident detecting unit for detecting an incident occurrence in the communication device;
a response policy storage unit for storing response information which is information indicative of the incident response that the incident response device should perform, and target information which is information to identify the communication device toward which the incident response is to be performed, with corresponding policy information expressive of a response policy to an incident;
a policy list output unit for outputting a list of the policy information stored in the response policy storage unit when an occurrence of the incident is detected;
a policy selection unit for receiving a selection of the policy information;
a response policy retrieving unit for retrieving the response information and the target information corresponding to the selected policy information, from the response policy storage unit; and
a command sending unit for sending the incident response device a command to perform the incident response based on the retrieved response information toward the communication device identified based on the retrieved target information.

2. The information processor according to claim 1,
wherein the incident response performed by the incident response device is at least any one of the following actions: blocking communications with the communication device, limiting users that access the communication device, updating a program stored in the communication device, and changing an access privilege on a file managed by the communication device.

3. The information processor according to claim 1,
wherein the information processor is communicably coupled with a detecting device that detects the incident occurrence in the communication device, and
the incident detecting unit detects the incident occurrence by receiving a message indicating that the incident has occurred in the communication device sent from the detecting device.

4. The information processor according to claim 1, further comprising:
a number-of-incident-occurrences calculating unit for calculating a number of the incident occurrences which is a number of the communication devices where the incident has occurred;
a responded-number calculating unit for calculating the number of responses which is the number of the communication devices identified based on the target information, for each of the policy information stored in the response policy storage unit; and
a recommendation-level determining unit for determining a recommendation level based on the number of responses and the number of the incident occurrences for each of the policy information stored in the response policy storage unit, and
wherein the policy list output unit outputs the list of the policy information in order of the recommendation level.

5. The information processor according to claim 1, wherein the communication device is coupled to a communication network containing a plurality of network segments, and
the response policy storage unit stores segment identifying information to identify each of the network segments, with the corresponding policy information, and
wherein the information processor further comprises:
a number-of-segments-involved-in-incident calculating unit for calculating a number of segments involved in the incident which is a number of the network segments connected with the communication devices where the incident has occurred;
a responded-number-of-target-segments calculating unit calculating the number of target segments which is the number of the network segments identified based on the segment identifying information for each of the policy information stored in the response policy storage unit; and
a recommendation-level determining unit for determining a recommendation level based on the number of target segments and the number of segments involved in the incident for each of the policy information stored in the response policy storage unit, and
wherein the policy list output unit outputs the list of the policy information in order of the recommendation level.

6. The information processor according to claim 5, further comprising:
a devices-for-each-segment storage unit for storing the communication devices connected to the network segment for each of the network segments; and
a target identifying unit for identifying other communication devices connected to the segment identified based on the segment identifying information with reference to the devices-for-each-segment storage unit when the incident occurrence is detected, and
wherein the command sending unit sends the incident response device a command to perform the incident responses to the other communication devices as well as to the communication device identified based on the target information.

7. The information processor according to claim 1,
wherein the communication device provides a plurality of services through a communication network, and the incident response is performed for the service,
the response policy storage unit stores service identifying information which is information to identify each of the services, with the corresponding policy information, and
the incident detecting unit detects the incident that has occurred in the services provided by the communication device, and
wherein the information processor further comprises:
a number-of-services-involved-in-incident calculating unit for calculating a number of services involved in the incident which is a number of the services in which the incident has occurred,
a number-of-target-services calculating unit for calculating a number of target services which is a number of the services identified based on the service identifying information for each of the policy information stored in the response policy storage unit; and
a recommendation-level determining unit for determining a recommendation level based on the number of target services and the number of services involved in the incident for each of the policy information stored in the response policy storage unit, and
wherein the policy list output unit outputs the list of the policy information in order of the recommendation level.

8. The information processor according to claim 7, further comprising:
a service storage unit for storing services provided by the communication device for each of the communication devices; and
a target identifying unit for identifying other communication devices that provide the services identified based on the service identifying information with reference to the service storage unit when the incident occurrence is detected, and
wherein the command sending unit sends the incident response device a command to perform the incident responses to the other communication devices as well as communication device identified based on the target information.

9. The information processor according to claim 1,
further comprising a restriction clear command input unit for receiving an input of a restriction clear command as a command to clear a restriction on the communication device, and
wherein the incident response performed by the incident response device is to control in that the communication device cannot receive data transmitted through a communication network, and
the command sending unit sends the incident response device a command to control the communication device to receive data transmitted through the communication network, in response to the input of the restriction clear command.

10. A method of controlling an incident response device by an information processor which controls the incident response device to perform an incident response toward a communication device, the method comprising the steps of:
detecting an incident occurrence in the communication device;
storing response information which is information indicative of the incident response that the incident response device should perform, and target information which is information to identify the communication device to which the incident response is to be performed, with corresponding policy information regarding a response policy to an incident, in a memory;
outputting a list of the policy information stored in the memory when the incident occurrence is detected;
receiving a selection of the policy information;
retrieving the response information and the target information corresponding to the selected policy information from the memory; and
sending the incident response device a command to perform the incident response based on the retrieved response information toward the communication device identified based on the retrieved target information.

11. A program product, comprising:
codes for causing a computer, which controls an incident response device to perform an incident response toward a communication device, to execute the following the steps of:
detecting an incident occurrence in the communication device;
storing response information which is information indicative of the incident response that the incident response device should perform, and target information which is information to identify the communication device toward which the incident response is to be performed, with corresponding policy information expressive of a response policy to an incident, in a memory;
outputting a list of the policy information stored in the memory when the incident occurrence is detected;
receiving a selection of the policy information;
retrieving the response information and the target information corresponding to the selected policy information from the memory; and
sending the incident response device a command to perform the incident response based on the retrieved response information toward the communication device identified based on the retrieved target information, and
a medium for embodying the codes, which is usable with the computer.
